(19) United States
(12) Patent Application Publication
(10) Pub. No.: US 2023/0128567 A1
(43) Pub. Date: Apr. 27, 2023

(54) ELASTIC ALLOCATION OF RESOURCES FOR OPTIMIZING EFFICIENCY OF PREDICTIVE ROUTING SYSTEMS

(71) Applicant: Cisco Technology, Inc., San Jose, CA (US)

(72) Inventors: Grégory Mermoud, Venthône (CH); Jean-Philippe VASSEUR, Saint Martin d'Uriage (FR); Vinay Kumar KOLAR, San Jose, CA (US); Pierre-André SAVALLE, Rueil-Malmaison (FR)

(21) Appl. No.: 17/507,043

(22) Filed: Oct. 21, 2021

(51) Int. Cl. H04L 12/751; H04L 12/24

(52) U.S. Cl. CPC H04L 45/08; H04L 41/147

(57) ABSTRACT

In one embodiment, a device computes an efficiency metric regarding ingestion of telemetry data from a particular portion of a network by a predictive routing engine used to make predictive routing decisions for that portion of the network. The device makes a comparison between the efficiency metric and one or more control rules. The device determines, based on the comparison, whether ingestion of the telemetry data from the particular portion of the network by the predictive routing engine should be disabled. The device causes the predictive routing engine to stop ingesting telemetry data from the particular portion of the network.

### TECHNICAL FIELD

The present disclosure relates generally to computer networks, and, more particularly, to the elastic allocation of resources for optimizing efficiency of predictive routing systems.

### BACKGROUND

Software-defined wide area networks (SD-WANs) represent the application of software-defined networking (SDN) principles to WAN connections, such as connections to cellular networks, the Internet, and Multiprotocol Label Switching (MPLS) networks. The power of SD-WAN is the ability to provide consistent service level agreement (SLA) for important application traffic transparently across various underlying tunnels of varying transport quality and allow for seamless tunnel selection based on tunnel performance characteristics that can match application SLAs and satisfy the quality of service (QoS) requirements of the traffic (e.g., in terms of delay, jitter, packet loss, etc.).

With the recent evolution of machine learning, predictive failure detection and proactive routing in an SDN/SD-WAN now becomes possible through the use of machine learning techniques. For instance, modeling the delay, jitter, packet loss, etc. for a network path can be used to predict when that path will violate the SLA of the application and reroute the traffic, in advance. However, it has been noted in practice that such predictions are only possible for a subset of network paths.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIGS. 3A-3B illustrate example network deployments;

FIGS. 4A-4B illustrate example software defined network (SDN) implementations;

FIG. 5 illustrates an example architecture for the elastic allocation of resources for optimizing efficiency of predictive routing systems; and

FIG. 6 illustrates an example simplified procedure for the elastic allocation of resources for optimizing efficiency of predictive routing systems.

### DESCRIPTION OF EXAMPLE EMBODIMENTS

### Overview

According to one or more embodiments of the disclosure, a device computes an efficiency metric regarding ingestion of telemetry data from a particular portion of a network by a predictive routing engine used to make predictive routing decisions for that portion of the network. The device makes a comparison between the efficiency metric and one or more control rules. The device determines, based on the comparison, whether ingestion of the telemetry data from the particular portion of the network by the predictive routing engine should be disabled. The device causes the predictive routing engine to stop ingesting telemetry data from the particular portion of the network.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

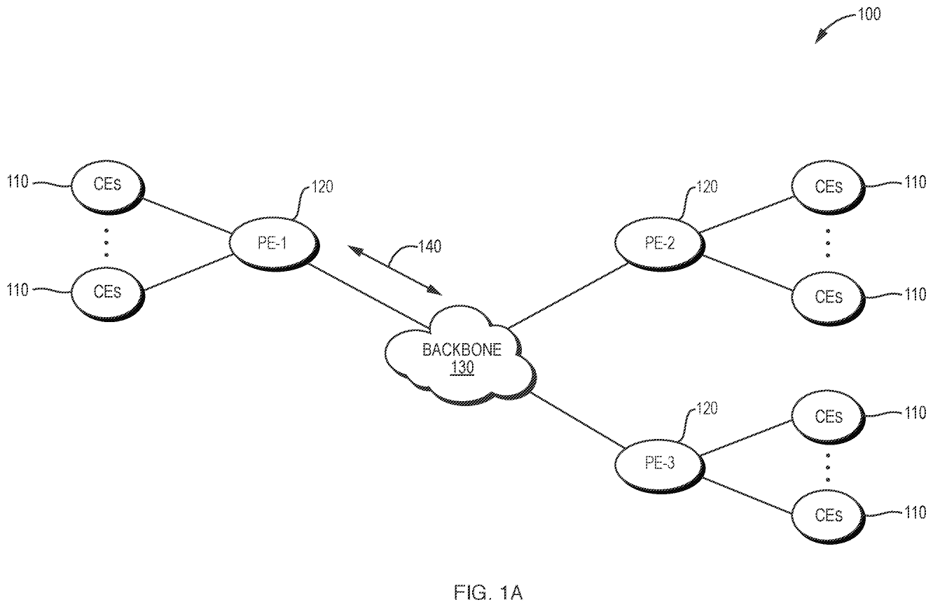

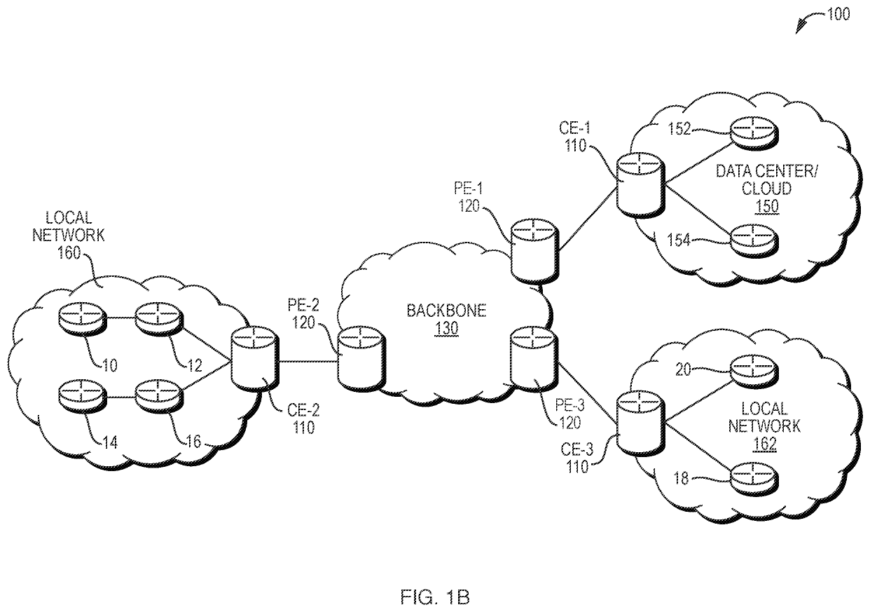

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.

2.) Site Type B: a site connected to the network by the CE router via two primary links (e.g., from different Service Providers), with potentially a backup link (e.g., a 3G/4G/5G/LTE connection). A site of type B may itself be of different types:

2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

According to various embodiments, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

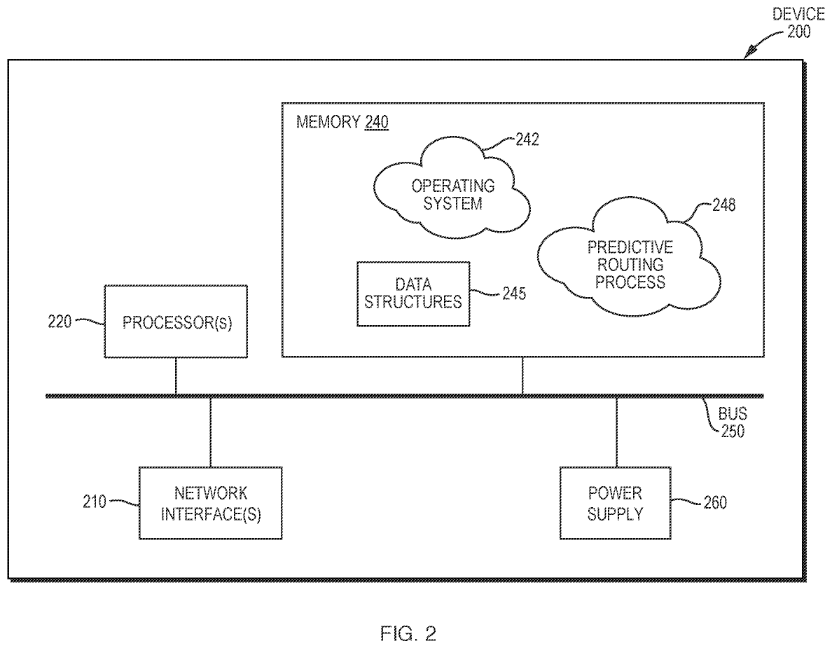

FIG. 2 is a schematic block diagram of an example node/device 200 (e.g., an apparatus) that may be used with one or more embodiments described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a predictive routing process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In general, predictive routing process 248 contains computer executable instructions executed by the processor 220 to perform routing functions in conjunction with one or more routing protocols. These functions may, on capable devices, be configured to manage a routing/forwarding table (a data structure 245) containing, e.g., data used to make routing/forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (e.g., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc.

In various embodiments, as detailed further below, predictive routing process 248 may include computer executable instructions that, when executed by processor(s) 220, cause device 200 to perform the techniques described herein. To do so, in some embodiments, predictive routing process 248 may utilize machine learning. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, predictive routing process 248 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that predictive routing process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

The performance of a machine learning model can be evaluated in a number of ways based on the number of true positives, false positives, true negatives, and/or false negatives of the model. For example, consider the case of a model that predicts whether the QoS of a path will satisfy the service level agreement (SLA) of the traffic on that path. In such a case, the false positives of the model may refer to the number of times the model incorrectly predicted that the QoS of a particular network path will not satisfy the SLA of the traffic on that path. Conversely, the false negatives of the model may refer to the number of times the model incorrectly predicted that the QoS of the path would be acceptable. True negatives and positives may refer to the number of times the model correctly predicted acceptable path performance or an SLA violation, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

As noted above, in software defined WANs (SD-WANs), traffic between individual sites are sent over tunnels. The tunnels are configured to use different switching fabrics, such as MPLS, Internet, 4G or 5G, etc. Often, the different switching fabrics provide different QoS at varied costs. For example, an MPLS fabric typically provides high QoS when compared to the Internet, but is also more expensive than traditional Internet. Some applications requiring high QoS (e.g., video conferencing, voice calls, etc.) are traditionally sent over the more costly fabrics (e.g., MPLS), while applications not needing strong guarantees are sent over cheaper fabrics, such as the Internet.

Traditionally, network policies map individual applications to Service Level Agreements (SLAs), which define the satisfactory performance metric(s) for an application, such as loss, latency, or jitter. Similarly, a tunnel is also mapped to the type of SLA that is satisfies, based on the switching fabric that it uses. During runtime, the SD-WAN edge router then maps the application traffic to an appropriate tunnel. Currently, the mapping of SLAs between applications and tunnels is performed manually by an expert, based on their experiences and/or reports on the prior performances of the applications and tunnels.

The emergence of infrastructure as a service (IaaS) and software-as-a-service (SaaS) is having a dramatic impact of the overall Internet due to the extreme virtualization of services and shift of traffic load in many large enterprises. Consequently, a branch office or a campus can trigger massive loads on the network.

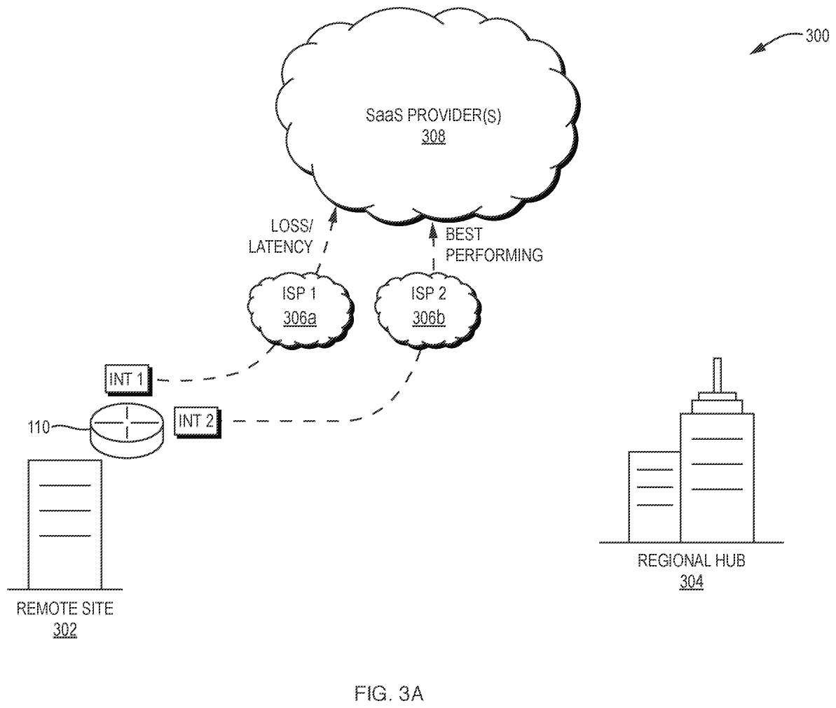

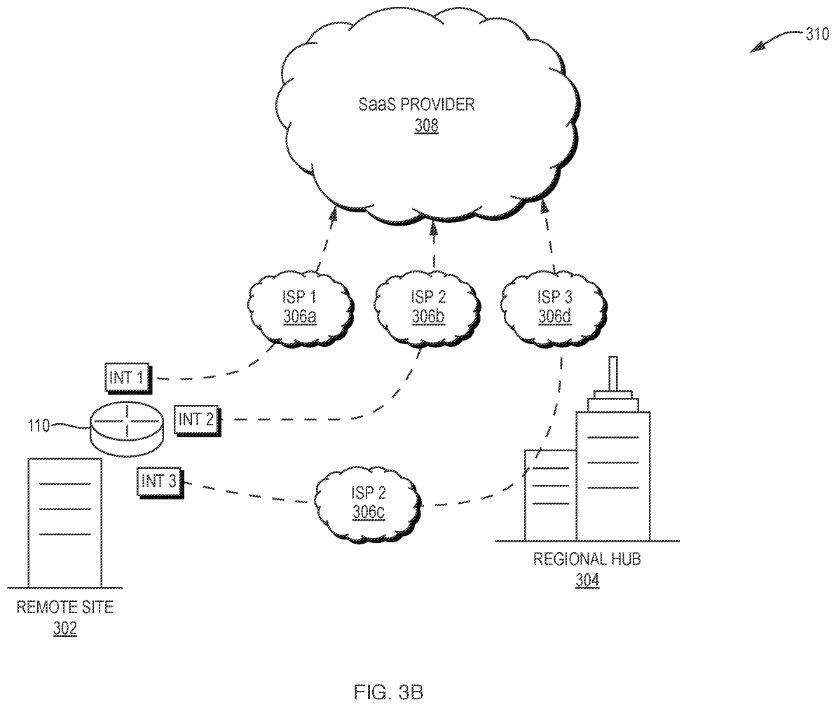

FIGS. 3A-3B illustrate example network deployments 300, 310, respectively. As shown, a router 110 located at the edge of a remote site 302 may provide connectivity between a local area network (LAN) of the remote site 302 and one or more cloud-based, SaaS providers 308. For example, in the case of an SD-WAN, router 110 may provide connectivity to SaaS provider(s) 308 via tunnels across any number of networks 306. This allows clients located in the LAN of remote site 302 to access cloud applications (e.g., Office 365™, Dropbox™, etc.) served by SaaS provider(s) 308.

As would be appreciated, SD-WANs allow for the use of a variety of different pathways between an edge device and an SaaS provider. For example, as shown in example network deployment 300 in FIG. 3A, router 110 may utilize two Direct Internet Access (DIA) connections to connect with SaaS provider(s) 308. More specifically, a first interface of router 110 (e.g., a network interface 210, described previously), Int 1, may establish a first communication path (e.g., a tunnel) with SaaS provider(s) 308 via a first Internet Service Provider (ISP) 306a, denoted ISP 1 in FIG. 3A. Likewise, a second interface of router 110, Int 2, may establish a backhaul path with SaaS provider(s) 308 via a second ISP 306b, denoted ISP 2 in FIG. 3A.

FIG. 3B illustrates another example network deployment 310 in which Int 1 of router 110 at the edge of remote site 302 establishes a first path to SaaS provider(s) 308 via ISP 1 and Int 2 establishes a second path to SaaS provider(s) 308 via a second ISP 306b. In contrast to the example in FIG. 3A, Int 3 of router 110 may establish a third path to SaaS provider(s) 308 via a private corporate network 306c (e.g., an MPLS network) to a private data center or regional hub 304 which, in turn, provides connectivity to SaaS provider(s) 308 via another network, such as a third ISP 306d.

Regardless of the specific connectivity configuration for the network, a variety of access technologies may be used (e.g., ADSL, 4G, 5G, etc.) in all cases, as well as various networking technologies (e.g., public Internet, MPLS (with or without strict SLA), etc.) to connect the LAN of remote site 302 to SaaS provider(s) 308. Other deployments scenarios are also possible, such as using Colo, accessing SaaS provider(s) 308 via Zscaler or Umbrella services, and the like.

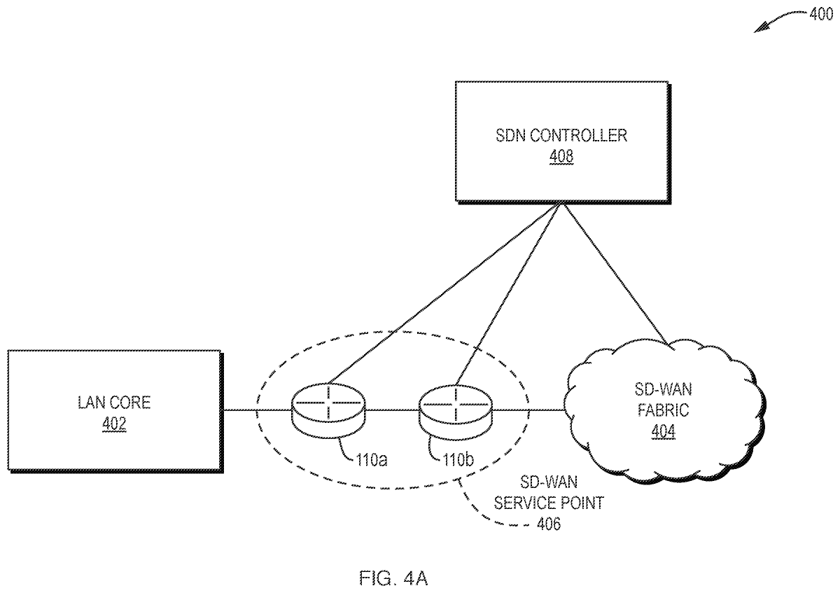

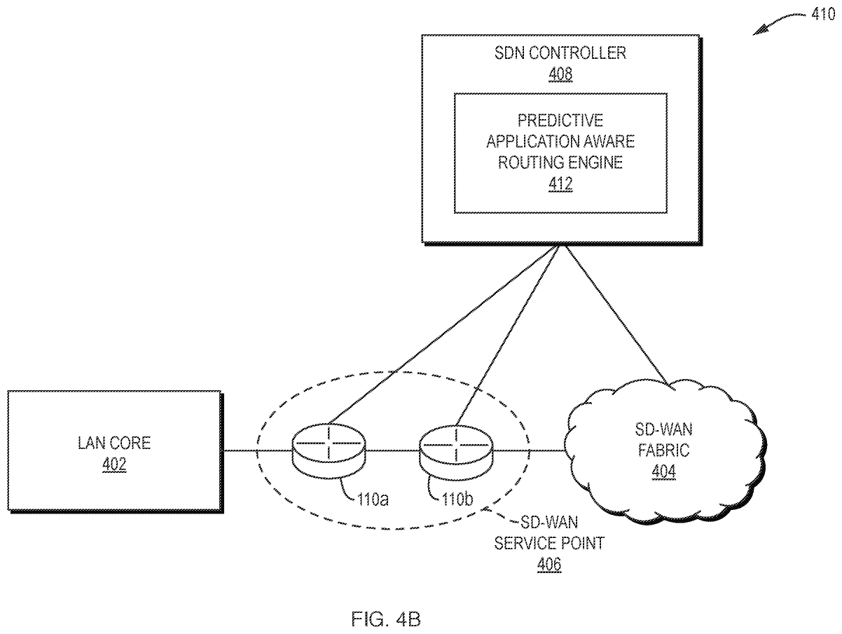

FIG. 4A illustrates an example SDN implementation 400, according to various embodiments. As shown, there may be a LAN core 402 at a particular location, such as remote site 302 shown previously in FIGS. 3A-3B. Connected to LAN core 402 may be one or more routers that form an SD-WAN service point 406 which provides connectivity between LAN core 402 and SD-WAN fabric 404. For instance, SD-WAN service point 406 may comprise routers 110a-110b.

Overseeing the operations of routers 110a-110b in SD-WAN service point 406 and SD-WAN fabric 404 may be an SDN controller 408. In general, SDN controller 408 may comprise one or more devices (e.g., a device 200) configured to provide a supervisory service, typically hosted in the cloud, to SD-WAN service point 406 and SD-WAN fabric 404. For instance, SDN controller 408 may be responsible for monitoring the operations thereof, promulgating policies (e.g., security policies, etc.), installing or adjusting IPsec routes/tunnels between LAN core 402 and remote destinations such as regional hub 304 and/or SaaS provider(s) 308 in FIGS. 3A-3B, and the like.

As noted above, a primary networking goal may be to design and optimize the network to satisfy the requirements of the applications that it supports. So far, though, the two worlds of “applications” and “networking” have been fairly siloed. More specifically, the network is usually designed in order to provide the best SLA in terms of performance and reliability, often supporting a variety of Class of Service (CoS), but unfortunately without a deep understanding of the actual application requirements. On the application side, the networking requirements are often poorly understood even for very common applications such as voice and video for which a variety of metrics have been developed over the past two decades, with the hope of accurately representing the Quality of Experience (QoE) from the standpoint of the users of the application.

More and more applications are moving to the cloud and many do so by leveraging an SaaS model. Consequently, the number of applications that became network-centric has grown approximately exponentially with the raise of SaaS applications, such as Office 365, ServiceNow, SAP, voice, and video, to mention a few. All of these applications rely heavily on private networks and the Internet, bringing their own level of dynamicity with adaptive and fast changing workloads. On the network side, SD-WAN provides a high degree of flexibility allowing for efficient configuration management using SDN controllers with the ability to benefit from a plethora of transport access (e.g., MPLS, Internet with supporting multiple CoS, LTE, satellite links, etc.), multiple classes of service and policies to reach private and public networks via multi-cloud SaaS.

Furthermore, the level of dynamicity observed in today's network has never been so high. Millions of paths across thousands of Service Provides (SPs) and a number of SaaS applications have shown that the overall QoS(s) of the network in terms of delay, packet loss, jitter, etc. drastically vary with the region, SP, access type, as well as over time with high granularity. The immediate consequence is that the environment is highly dynamic due to:
New in-house applications being deployed;
New SaaS applications being deployed everywhere in the network, hosted by a number of different cloud providers;
Internet, MPLS, LTE transports providing highly varying performance characteristics, across time and regions;
SaaS applications themselves being highly dynamic: it is common to see new servers deployed in the network. DNS resolution allows the network for being informed of a new server deployed in the network leading to a new destination and a potentially shift of traffic towards a new destination without being even noticed.

According to various embodiments, application aware routing usually refers to the ability to rout traffic so as to satisfy the requirements of the application, as opposed to exclusively relying on the (constrained) shortest path to reach a destination IP address. Various attempts have been made to extend the notion of routing, CSPF, link state routing protocols (ISIS, OSPF, etc.) using various metrics (e.g., Multi-topology Routing) where each metric would reflect a different path attribute (e.g., delay, loss, latency, etc.), but each time with a static metric. At best, current approaches rely on SLA templates specifying the application requirements so as for a given path (e.g., a tunnel) to be “eligible” to carry traffic for the application. In turn, application SLAs are checked using regular probing. Other solutions compute a metric reflecting a particular network characteristic (e.g., delay, throughput, etc.) and then selecting the supposed ‘best path,’ according to the metric.

The term ‘SLA failure’ refers to a situation in which the SLA for a given application, often expressed as a function of delay, loss, or jitter, is not satisfied by the current network path for the traffic of a given application. This leads to poor QoE from the standpoint of the users of the application. Modern SaaS solutions like Viptela, CloudonRamp SaaS, and the like, allow for the computation of per application QoE by sending HyperText Transfer Protocol (HTTP) probes along various paths from a branch office and then route the application's traffic along a path having the best QoE for the application. At a first sight, such an approach may solve many problems. Unfortunately, though, there are several shortcomings to this approach:
The SLA for the application is ‘guessed,’ using static thresholds.
Routing is still entirely reactive: decisions are made using probes that reflect the status of a path at a given time, in contrast with the notion of an informed decision.
SLA failures are very common in the Internet and a good proportion of them could be avoided (e.g., using an alternate path), if predicted in advance.

In various embodiments, the techniques herein allow for a predictive application aware routing engine to be deployed, such as in the cloud, to control routing decisions in a network. For instance, the predictive application aware routing engine may be implemented as part of an SDN controller (e.g., SDN controller 408) or other supervisory service, or may operate in conjunction therewith. For instance, FIG. 4B illustrates an example 410 in which SDN controller 408 includes a predictive application aware routing engine 412 (e.g., through execution of predictive routing process 248). Further embodiments provide for predictive application aware routing engine 412 to be hosted on a router 110 or at any other location in the network.

During execution, predictive application aware routing engine 412 makes use of a high volume of network and application telemetry (e.g., from routers 110a-110b, SD-WAN fabric 404, etc.) so as to compute statistical and/or machine learning models to control the network with the objective of optimizing the application experience and reducing potential down times. To that end, predictive application aware routing engine 412 may compute a variety of models to understand application requirements, and predictably route traffic over private networks and/or the Internet, thus optimizing the application experience while drastically reducing SLA failures and downtimes.

In other words, predictive application aware routing engine 412 may first predict SLA violations in the network that could affect the QoE of an application (e.g., due to spikes of packet loss or delay, sudden decreases in bandwidth, etc.). In other words, predictive application aware routing engine 412 may use SLA violations as a proxy fir actual QoE information (e.g., ratings by users of an online application regarding their perception of the application), unless such QoE information is available from the provider of the online application. In turn, predictive application aware routing engine 412 may then implement a corrective measure, such as rerouting the traffic of the application, prior to the predicted SLA violation. For instance, in the case of video applications, it now becomes possible to maximize throughput at any given time, which is of utmost importance to maximize the QoE of the video application. Optimized throughput can then be used as a service triggering the routing decision for specific application requiring highest throughput, in one embodiment. In general, routing configuration changes are also referred to herein as routing “patches,” which are typically temporary in nature (e.g., active for a specified period of time) and may also be application-specific (e.g., for traffic of one or more specified applications).

As noted above, predictive application aware routing engine 412 may make routing forecasts to avoid application experience disruptions along various paths on the Internet or other network. However, such forecasts are only possible for a subset of the paths, which exhibit some predictive patterns. In other words, some portions of the networks under the control of predictive application aware routing engine 412 may not experience any real reduction in poor application quality.

### Elastic Allocation of Resources for Optimizing Efficiency of Predictive Routing Systems

The techniques introduced herein allow a predictive routing system to adjust dynamically the portions of network it processes in order to optimize its efficiency in terms of cost, energy usage, carbon emissions, or the like. Indeed, for portions of the network for which predictive routing is ineffective, the resource cost of ingesting telemetry data from those portions may be such that disabling the ingestion makes more sense. This can also reduce the privacy exposure for the data, by guaranteeing that only data that is actually useful due to network disruption is even collected and stored at all by the system.

Illustratively, the techniques described herein may be performed by hardware, software, and/or firmware, such as in accordance with predictive routing process 248, which may include computer executable instructions executed by the processor 220 (or independent processor of interfaces 210) to perform functions relating to the techniques described herein.

Specifically, according to various embodiments, a device computes an efficiency is metric regarding ingestion of telemetry data from a particular portion of a network by a predictive routing engine used to make predictive routing decisions for that portion of the network. The device makes a comparison between the efficiency metric and one or more control rules. The device determines, based on the comparison, whether ingestion of the telemetry data from the particular portion of the network by the predictive routing engine should be disabled. The device causes the predictive routing engine to stop ingesting telemetry data from the particular portion of the network.

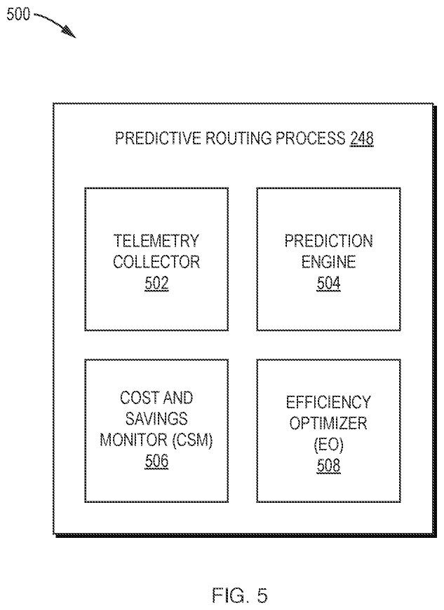

Operationally, FIG. 5 illustrates an example architecture 500 for the elastic allocation of resources for optimizing efficiency of predictive routing systems, according to various embodiments. At the core of architecture 500 is predictive routing process 248, which may be executed by a controller for a network or another device in communication therewith. For instance, predictive routing process 248 may be executed by a controller for a network (e.g., SDN controller 408 in FIGS. 4A-4B), a particular networking device in the network (e.g., a router, etc.), another device or service in communication therewith, or the like. In some embodiments, for instance, predictive routing process 248 may be used to implement a predictive application aware routing engine, such as predictive application aware routing engine 412.

As shown, predictive routing process 248 may include any or all of the following components: a telemetry collector 502, a prediction engine 504, a cost and savings monitor (CSM) 506, and/or an efficiency optimizer (EO) 508. As would be appreciated, the functionalities of these components may be combined or omitted, as desired. In addition, these components may be implemented on a singular device or in a distributed manner, in which case the combination of executing devices can be viewed as their own is singular device for purposes of executing predictive routing process 248.

Telemetry collector 502 may generally be operable to obtain telemetry data regarding different portions of a network for analysis. Such telemetry data may include Netflow or IPFIX record information, application information, path information (e.g., delay, jitter, loss, throughput, etc.), SLA information, combinations thereof, or the like. In some embodiments, telemetry collector 502 may also obtain QoE metrics from an application provider, such as via an application programming interface (API). These metrics may be based on user-provided ratings regarding their satisfaction with the application. In other embodiments, predictive routing process 248 may use a proxy metric for the QoE, such as SLA violations. In various implementations, the telemetry data may be sent to telemetry collector 502 on a pull basis or on a push basis.

Prediction engine 504 may ingest the telemetry data obtained by telemetry collector 502, to predict degraded application quality. More specifically, prediction engine 504 may comprise one or more machine learning models, to predict when the application quality in a particular portion of the network is likely to be unacceptable. In turn, prediction engine 504 may opt to reroute some or all of the affected application traffic, so as to avoid these disruptions.

As would be appreciated, the portion of the network for which prediction engine 504 makes predictions may be at different levels of granularity. For instance, the portion of the network may take the form of an edge router or set of routers, a set of one or more network paths, a geographic location (e.g., a city, state, region, country, etc.), service provider, such as a particular Internet Service Provider (ISP), autonomous system (AS), or the like.

A key observation is that prediction engine 504 may not be able to reliably predict application experience degradations for all portions of a network. Indeed, there may be some portions of a network that simply do not exhibit patterns on which predictions can be made.

According to various embodiments, predictive routing process 248 may also include a cost and savings monitor (CSM) 506 that is responsible for tracking, at various levels (e.g., path, ISP, router, city, country), the “costs” incurred by the processing of the telemetry from a certain portion of the network and its corresponding savings (e.g., in terms of prevented application quality degradation). In various embodiments, the cost associated with the telemetry collection and ingestion may represent one or more resource consumptions (e.g., in terms of processing usage, memory usage, bandwidth usage, etc.), a power consumption, a carbon emission, an actual monetary cost, combinations thereof, or the like.

In some embodiments, CSM 506 may attribute costs back to an entity using multiple techniques:
Rough approximation based on their size/size/number of records/number of children entities, and on the total processing cost.
Ablation studies: for instance, a given city is disabled from processing, the difference in actual cost could be attributed in part to that city, all other things being equal. This can help validate rough approximations.

According to further embodiments, predictive routing process 248 may also include efficiency optimizer (EO) 508, which uses one or more control rules, to optimize the efficiency of the system. For instance, in one embodiment, EO 508 may set a threshold TS on the minimum efficiency required to process a given area A. Additional threshold rules can also be set, in further embodiments. For example, a threshold rule can be set based on minimum efficacy (TS) and minimum absolute savings (TAS). When such a threshold is not met, EO 508 may halt the ingestion of telemetry data for that specific portion of the network.

Disabling the ingestion of telemetry from a certain portion of the network can be achieved in a number of ways. In one embodiment, this could be done directly by telemetry collector 502, such as by simply discarding the telemetry data from that portion of the network. In other embodiments, EO 508 may explicitly notify one or more devices in that portion of the network to stop sending telemetry data about that portion of the network.

In another embodiment, EO 508 may opt to reduce the sampling rate of the telemetry data for that portion of the network (e.g., by going for a coarser time granularity), in order to adjust the tradeoff between cost and forecasting accuracy when this is supported by prediction engine 504. As area in the network are deactivated and their telemetry is no longer ingested, relevant computing, storage, and networking infrastructure can be torn down dynamically, thus reducing their resource consumptions.

In other embodiments, EO 508 may set its threshold by learning from the distribution of efficacy measurements. For instance, CSM 506 may compute savings for the top 95% of the paths and the threshold TS may corresponds to the 95th percentile of efficacy.

In yet another embodiment, EO 508 may send a request to the network owner so as to confirm that ingestion should indeed be stopped. Indeed, it is common for networks to have areas with different levels of criticality. Of course, if the user still requests the processing of data, even in absence of any saving, then the system may switch to a different mode of determining the cost (e.g., based on the volume of data).

Another potential aspect of EO 508 may be the ability to re-evaluate the efficiency metric/score S for a particular portion of the network, such as at regular intervals, on demand, etc. For instance, assume that data ingestion for a given area A was deactivated two weeks ago because its score S was 25% below the threshold. In such a case, EO 508 may reactivate it temporarily in order to get a new estimate of its score S. If the new score received from CSM 506 is within the expected range, then EO 508 may again deactivate data ingestion again for the area. If the score deviates from the previous estimate, EO 508 may continue to collect data until another decision can be made. To this end, a Bayesian model can be used, which internally maintains a distribution of the estimated score S for every area A and refines this distribution for every sample of S produced by CSM 506. In absence of measurements, or with measurements at odds with the current estimate, the variance of the distribution is updated to account for the increase is in uncertainty and the change. This approach allows for EO 508 to constantly decide whether it should deactivate area A (e.g., because its estimate of S is reliably below the threshold) or it should activate ingestion for that area (e.g., because its estimate of S is likely to be above the threshold).

In various embodiments, EO 508 may also present a user interface that allows an end user to review the efficiency score of various portions of the network and adjust the threshold TS used by EO 508 to activate or deactivate the ingestion of telemetry data from them. This interface can consist of a table that can be ranked and/or filtered by various attributes (e.g., geographic region, savings, efficiency, cost) or a heatmap overlaid on top of a geographic map or a network topology. Regardless of the exact format, the user may adjust the threshold in order to allow the system to be less efficient in some areas that are particularly important. In yet another embodiment, such variables may be provided to a policy engine administered by the user. The user may also adjust this threshold in order to make the overall system more cost-efficient or more environmentally-friendly.

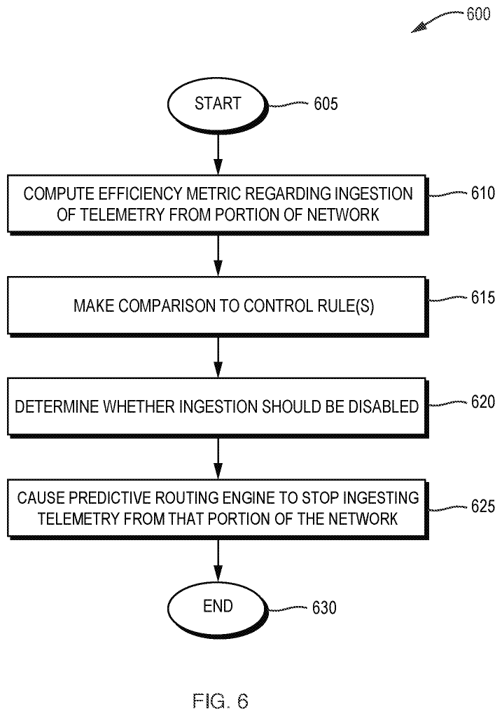

FIG. 6 illustrates an example simplified procedure 600 (e.g., a method) for the elastic allocation of resources for optimizing efficiency of predictive routing systems, in accordance with one or more embodiments described herein. For example, a non-generic, specifically configured device (e.g., device 200), such as controller for a network (e.g., an SDN controller, an edge router, or other device in communication therewith), may perform procedure 600 by executing stored instructions (e.g., predictive routing process 248). The procedure 600 may start at step 605, and continues to step 610, where, as described in greater detail above, the device may compute an efficiency metric regarding ingestion of telemetry data from a particular portion of a network by a predictive routing engine used to make predictive routing decisions for that portion of the network. In various embodiments, the particular portion of the network may take the form of a particular path, router, ISP, or geographic area.

At step 615, as detailed above, the device may make a comparison between the efficiency metric and one or more control rules. In some embodiments, the efficiency metric is based on a processing cost associated with the telemetry data from the particular portion of the network. For instance, the efficiency metric may take the form of a ratio of those processing costs to the observed benefit of applying the predictive routing engine to that portion of the network (e.g., in terms of prevented application degradation, avoided SLA violations, etc.).

At step 620, the device may determine, based on the comparison, whether ingestion of the telemetry data from the particular portion of the network by the predictive routing engine should be disabled, as described in greater detail above. For instance, if the efficiency metric is below a user-defined threshold, the device may determine that the ingestion should be disabled.

At step 625, as detailed above, the device may cause the predictive routing engine to stop ingesting telemetry data from the particular portion of the network. In some embodiments, the device may do so by instructing one or more networking devices in the particular portion of the network to stop sending telemetry data for ingestion by the predictive routing engine. In other embodiments, the device may do so by discarding telemetry data received from the particular portion of the network, to prevent it from being ingested by the predictive routing engine. In one embodiment, the device may even re-enable, temporarily, ingestion of telemetry data from the particular portion of the network, to reassess its efficiency metric. Procedure 600 then ends at step 630.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

While there have been shown and described illustrative embodiments that provide for the elastic allocation of resources for optimizing efficiency of predictive routing systems, it is to be understood that various other adaptations and modifications may be made within the spirit and scope of the embodiments herein. For example, while certain embodiments are described herein with respect to using certain models for purposes of predicting application experience metrics, SLA violations, or other disruptions in a network, the models are not limited as such and may be used for other types of predictions, in other embodiments. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

1. A method comprising:
computing, by a device, an efficiency metric regarding ingestion of telemetry data from a particular portion of a network by a predictive routing engine used to make predictive routing decisions for that portion of the network;
making, by the device, a comparison between the efficiency metric and one or more control rules;
determining, by the device and based on the comparison, whether ingestion of the telemetry data from the particular portion of the network by the predictive routing engine should be disabled; and
causing, by the device, the predictive routing engine to stop ingesting telemetry data from the particular portion of the network.

2. The method as in claim 1, wherein the particular portion of the network comprises a particular path or router in the network.

3. The method as in claim 1, wherein the particular portion of the network comprises a particular Internet Service Provider (ISP).

4. The method as in claim 1, wherein the particular portion of the network comprises a geographic area.

5. The method as in claim 1, wherein causing the predictive routing engine to stop ingesting telemetry data from the particular portion of the network comprises:
instructing one or more networking devices in the particular portion of the network to stop sending telemetry data for ingestion by the predictive routing engine.

6. The method as in claim 1, wherein causing the predictive routing engine to stop ingesting telemetry data from the particular portion of the network comprises:
discarding telemetry data received from the particular portion of the network, to prevent it from being ingested by the predictive routing engine.

7. The method as in claim 1, further comprising:
re-enabling, temporarily, ingestion of telemetry data from the particular portion of the network, to reassess its efficiency metric.

8. The method as in claim 1, wherein the efficiency metric is based on a processing cost associated with the telemetry data from the particular portion of the network.

9. The method as in claim 1, wherein the one or more control rules comprise a user-defined threshold for the efficiency metric.

10. The method as in claim 1, wherein the efficiency metric is based in part on a performance metric for the predictive routing engine with respect to its predictive routing decisions for that portion of the network.

11. An apparatus, comprising:
one or more network interfaces;
a processor coupled to the one or more network interfaces and configured to execute one or more processes; and
a memory configured to store a process that is executable by the processor, the process when executed configured to:
compute an efficiency metric regarding ingestion of telemetry data from a particular portion of a network by a predictive routing engine used to make predictive routing decisions for that portion of the network;
make a comparison between the efficiency metric and one or more control rules;
determine, based on the comparison, whether ingestion of the telemetry data from the particular portion of the network by the predictive routing engine should be disabled; and
cause the predictive routing engine to stop ingesting telemetry data from the particular portion of the network.

12. The apparatus as in claim 11, wherein the particular portion of the network comprises a particular path or router in the network.

13. The apparatus as in claim 11, wherein the particular portion of the network comprises a particular Internet Service Provider (ISP) or geographic area.

14. The apparatus as in claim 11, wherein the apparatus causes the predictive routing engine to stop ingesting telemetry data from the particular portion of the network by:
instructing one or more networking devices in the particular portion of the network to stop sending telemetry data for ingestion by the predictive routing engine.

15. The apparatus as in claim 11, wherein the apparatus causes the predictive routing engine to stop ingesting telemetry data from the particular portion of the network by:
discarding telemetry data received from the particular portion of the network, to prevent it from being ingested by the predictive routing engine.

16. The apparatus as in claim 11, wherein the process when executed is further configured to:
re-enable, temporarily, ingestion of telemetry data from the particular portion of the network, to reassess its efficiency metric.

17. The apparatus as in claim 11, wherein the efficiency metric is based on a processing cost associated with the telemetry data from the particular portion of the network.

18. The apparatus as in claim 11, wherein the one or more control rules comprise a user-defined threshold for the efficiency metric.

19. The apparatus as in claim 11, wherein the efficiency metric is based in part on a performance metric for the predictive routing engine with respect to its predictive routing decisions for that portion of the network.

20. A tangible, non-transitory, computer-readable medium storing program instructions that cause a device to execute a process comprising:
computing, by the device, an efficiency metric regarding ingestion of telemetry data from a particular portion of a network by a predictive routing engine used to make predictive routing decisions for that portion of the network;
making, by the device, a comparison between the efficiency metric and one or more control rules;
determining, by the device and based on the comparison, whether ingestion of the telemetry data from the particular portion of the network by the predictive routing engine should be disabled; and
causing, by the device, the predictive routing engine to stop ingesting telemetry data from the particular portion of the network.
